(19) United States
(12) Patent Application Publication
(10) Pub. No.: US 2018/0016756 A1
(43) Pub. Date: Jan. 18, 2018

(54) METHOD AND APPARATUS FOR FILLING POTHOLES WITH LIQUID POTHOLE FILLER

(71) Applicants: James E. Beckman, Muskegon, MI (US); Robert W. Beckman, Shelby, MI (US); Daniel J. Verschueren, Pentwater, MI (US)

(72) Inventors: James E. Beckman, Muskegon, MI (US); Robert W. Beckman, Shelby, MI (US); Daniel J. Verschueren, Pentwater, MI (US)

(21) Appl. No.: 15/210,844

(22) Filed: Jul. 14, 2016

(51) Int. Cl. E01C 7/18; E01C 11/00; E01C 23/09; F16C 11/04

(52) U.S. Cl. CPC E01C 7/187; F16C 11/04; E01C 11/005; E01C 23/0973

(57) ABSTRACT

A pothole filling method and apparatus with a separate liquid asphalt tank, aggregate hopper, and activator container, and having and using one or more of the following features:
1. Compressed air to deliver the liquid asphalt component from the liquid asphalt tank to the mixing head;
2. A swivel between extender delivery conduits, with an internal sleeve for guiding aggregate and protecting the swivel bearings;
3. A water cleaning system being switchable between a clean out line connected directly to a mixing/delivery unit or to the liquid asphalt delivery line, which cleans the delivery line as well as the mixing/delivery unit;
4. A mixer/delivery unit clean out is provided, wherein the unit is operated at increased speed a short time after the unit stops operating;
5. Compressed air bubbler or an air driven stirrer for mixing the liquid component.
6. A generally vertically oriented funnel shaped activator holder with a generally vertically oriented motorized auger extending to a delivery tube, to deliver activator to a mixing/delivery unit.

### FIELD OF THE INVENTION

The present invention relates to the field of methods and apparatus for filling potholes with liquid pothole filler.

### BACKGROUND OF THE INVENTION

Liquid pothole filler compositions comprise an asphalt emulsion and a separate aggregate material such as a low density pumice powder (500 kg/m³). The two ingredients are mixed together in situ immediately prior to use. A small amount of activator may also be incorporated into the mix in situ. The resulting mixture is poured into the pothole as a liquid mixture, where it cures into a hard compound.

One apparatus for in-situ mixing and filling potholes with such a liquid composition is disclosed in U.S. Patent Application Publication 2009/0303828 entitled METHOD OF FILLING POTHOLES AND APPARATUS FOR PERFORMING SAME, owned by RING-O-MATIC MFG. CO., INC. of Pella, Iowa. The apparatus uses a pump to pump liquid out of a liquid container, and an agitator to help keep it in suspension. The aggregate is maintained in a hopper, from which it is delivered by an auger in the hopper to two serial extender augers. The activator is maintained in a tumbler, which drops the activator into one of the aggregate extender auger through a delivery tube. The extender augers deliver the aggregate and activator mix to a mixing auger. The pumped liquid asphalt mix is also pumped into the mixer auger, where it is mixed with the aggregate and the activator mix.

### SUMMARY OF THE INVENTION

The apparatus and method of the present invention utilize an apparatus with separate liquid asphalt tank, aggregate hopper, and activator container, having and using one or more of the following features:

1. Compressed air to deliver the liquid asphalt component from the liquid asphalt tank to the mixing head;

2. A swivel between extender delivery conduits, with an internal sleeve for guiding aggregate and protecting the swivel bearings;

3. A water cleaning system being switchable between a clean out line connected directly to a mixing/delivery unit or to the liquid asphalt delivery line, which cleans the delivery line as well as the mixing/delivery unit;

4. A mixer/delivery unit clean out is provided, wherein the unit is operated at increased speed a short time after the unit stops dispensing/mixing;

5. Compressed air bubbler or a motor driven stirrer for mixing the liquid component.

6. A generally vertically oriented funnel shaped activator holder with a generally vertically oriented motorized auger extending to a delivery tube, to deliver activator to a mixing/delivery unit.

Additional features, advantages and objects of the present invention will be more fully understood and appreciated by reference to the Description of the Preferred Embodiments, and appended drawings.

### BRIEF DESCRIPTION OF THE DRAWINGS

FIG. 1 is an elevated, rear left corner perspective view of the apparatus;

FIG. 2 is an elevated rear right corner perspective view of the apparatus, with the extender and mixer augers extended;

FIG. 3 is a partial cross sectional view of the liquid asphalt tank and the air compressor, compressor tank, regulator and delivery tubes for bubbling and pressurizing the liquid asphalt tank;

FIG. 4 is an enlarged partial cross sectional view of the threaded liquid asphalt tank cover, and its connection to the bubbler;

FIG. 4A is an enlarged partial cross sectional view of the threaded liquid asphalt tank cover, and its connection to an air driven stirrer;

FIG. 5 is a perspective view of the funnel shaped activator holder and feed, and the aggregate hopper, and its connection to the aggregate delivery auger;

FIG. 6 is an elevational view of the extender and mixer augers, the swivel joint between the extender augers, and the connection of the water flush system and the liquid asphalt system to the mixer auger;

FIG. 7 is a cross sectional view of swivel between the extender augers;

FIG. 8 is an exploded perspective view of the components of the swivel between the extender augers; and

FIG. 9 is an elevational view showing the water flush tank, the liquid asphalt tank, the mixing auger and the connections there between.

### DESCRIPTION OF THE PREFERRED EMBODIMENTS

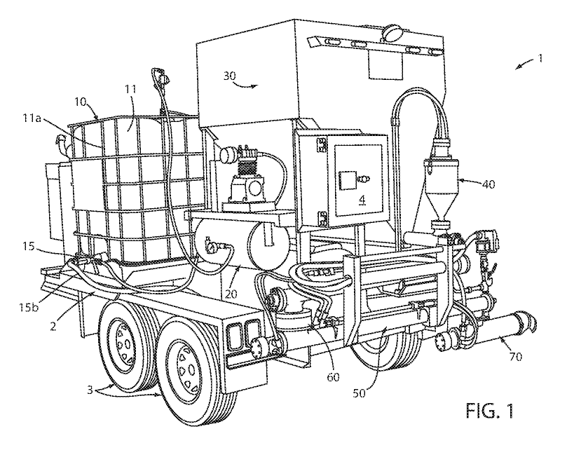

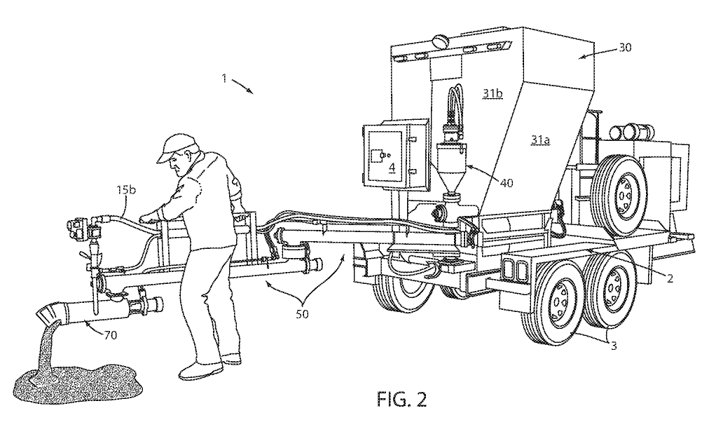

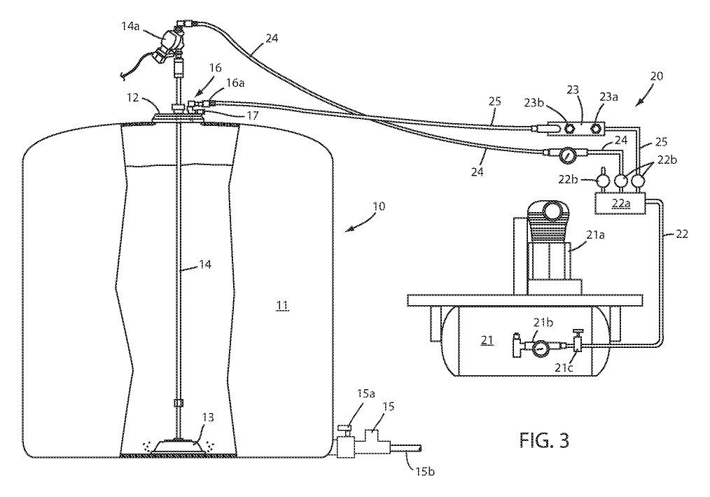

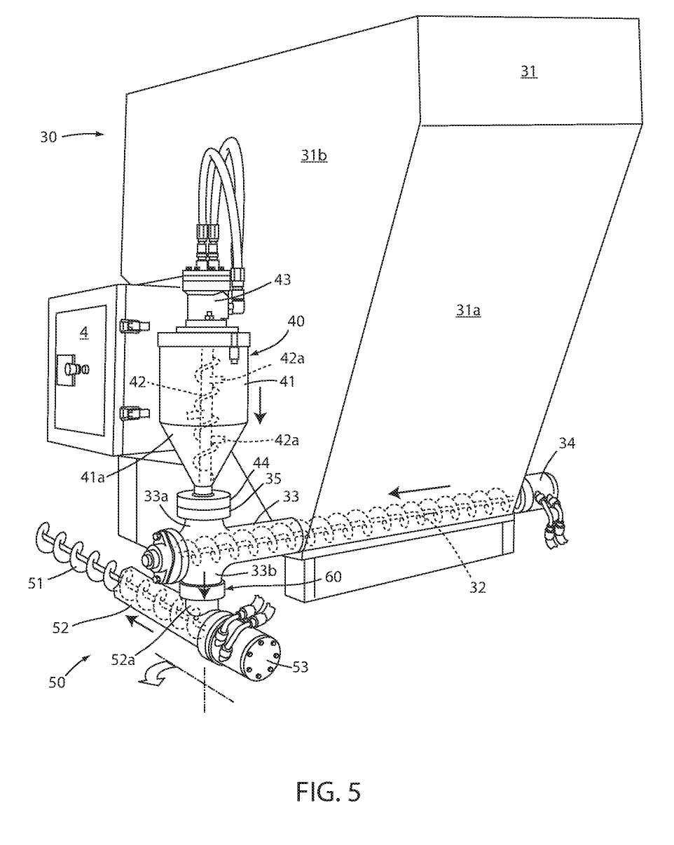

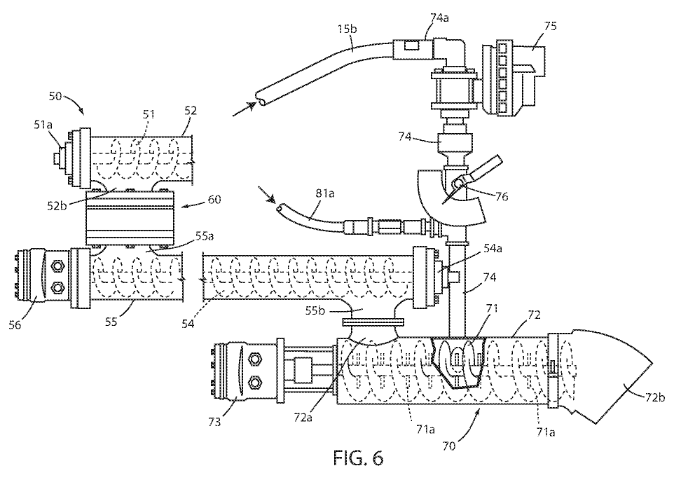

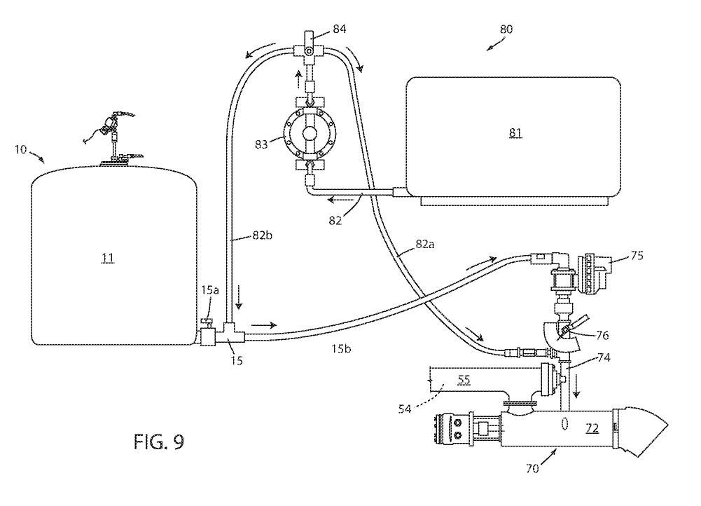

In the preferred embodiments, the pothole filling apparatus 1 comprises a chassis 2, with wheels 3 for mobility, and a computer controller unit 4 (FIGS. 1 and 2). Mounted on chassis 2 are a liquid asphalt delivery system 10, a compressed air system 20, an aggregate delivery system 30, an activator delivery system 40, a delivery extender system 50, a mixing and delivery unit 70, and water clean out system 80. Compressed air system 20 feeds compressed air to the liquid asphalt system to provide intermittent stirring, and to deliver liquid asphalt to the mixing and delivery unit 70 through conduit 15b (FIGS. 3, 4 and 6). Aggregate system stores and delivers aggregate to mixing and delivery unit 70 via the delivery extender system 50 (FIGS. 5 and 6). Activator system 40 delivers activator to mixing and delivery unit 70 also via delivery extender system 50, in which activator is mixed with aggregate as it is transported. Water clean out system 80 pumps clean out water either directly to mixer unit 70 via delivery line 82a, or via delivery line 82b to and then through liquid asphalt delivery line 15b (FIG. 9).

The various components which will be discussed herein are listed and numbered in the following components list:

Pothole filling apparatus 1

Chassis 2

Wheels 3

Computer controller unit 4

Liquid asphalt delivery system 10
Liquid asphalt container 11
Container holding frame 11a
Container cap 12
Bubbler 13
Bubbler air delivery tube 14
Computer controlled valve 14a
Quick disconnect 14b
Tank outlet flow spigot 15
Outlet spigot valve 15a
Liquid asphalt delivery conduit 15b
Pressurizing connector fitting 16
Quick disconnect 16a
Pressure relief valve 17
Air driven stirrer 18
   Mixing motor 18a
   Propeller or paddle stirrer 18b
Air exhaust line 19

Compressed air system 20
Compressor 21
Compressed air line 22
Manifold 22a
Manifold port shut off valves 22b
Step down regulator assembly 23
   30 psi regulator 23a
   4-6 psi regulator 23b
Mixing air delivery line 24
Pressurizing air line 25

Aggregate delivery system 30
Aggregate hopper 31
Downwardly and inwardly sloping tank sides 31a
Aggregate delivery auger 32
Auger conduit 33
Auger conduit top inlet 33a
Auger conduit bottom outlet 33b
Auger drive motor 34
Connector ring 35

Activator delivery system 40
Activator container 41
Funnel shaped bottom portion 41a
Activator delivery auger 42
Paddles 42b
Auger motor 43
Connector ring 44.

Delivery extender system 50
First auger 51
   Auger bearing 51a
First auger conduit 52
   Conduit inlet 52a
   Conduit outlet 52b
First auger drive motor 53
Second auger 54
   Auger bearing 54a
Second auger conduit 55
   Conduit inlet 55a
   Conduit outlet 55b
Second auger drive motor 56

Swivel joint 60
61 bearing and inner race assembly
62 bearing outer race
63 bearing housing
   63a upper retainer lip 63
64 inner sleeve
   64a inner sleeve bottom retainer lip
65 bottom retainer ring
66 bottom connector ring
67 spacer
68 upper securement ring
69 top connector ring

Mixing and delivery unit 70
Mixing/delivery auger 71
   Mixing tines 71a
Mixing auger conduit 72
   inlet 72a
   outlet spout 72b
auger motor 73
Liquid asphalt delivery pipe 74
   Quick disconnect connector 74a
Liquid asphalt flow meter 75
Liquid asphalt delivery valve 76

Water clean out system 80.
Water tank 81
Water delivery line 82a
Water delivery line 82b
Water pump 83
Water diverter valve 84

The liquid asphalt delivery system 10 comprises a liquid asphalt container 11, which can comprise a tote which is loaded into and out of a holding frame 11a (FIG. 1). The liquid asphalt can be shipped and stored in “totes” or containers 11, and then placed in holding frame 11a for use. Alternatively container 11 can be a fixed container which is filled for use.

A cap 12 which screws on to the open top of container 11 and a spigot 15 provides an outlet at the bottom of container 11 (FIG. 3). Spigot 15 includes a valve 15a for opening and closing, and a liquid asphalt delivery line 15b which is releasably secured to spigot 15 for delivering liquid asphalt to mixer/delivery unit 70. When a fresh container 11 is placed in frame 11a, delivery line 11b is connected to spigot 15, and valve 15a is opened, thereby allowing liquid asphalt to flow.

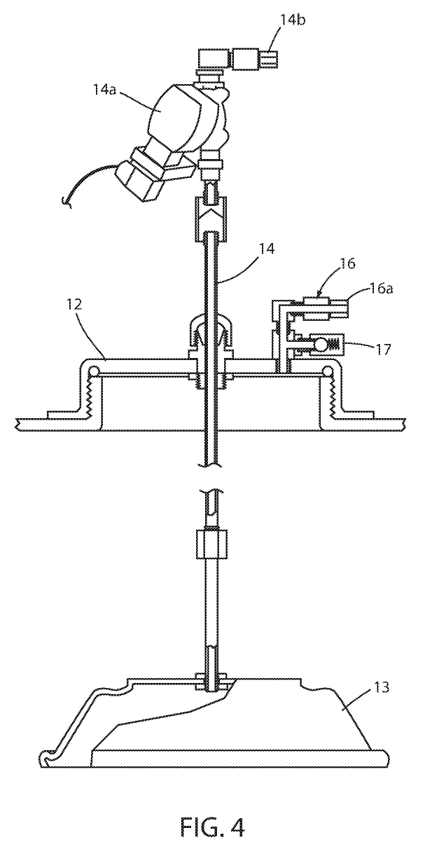

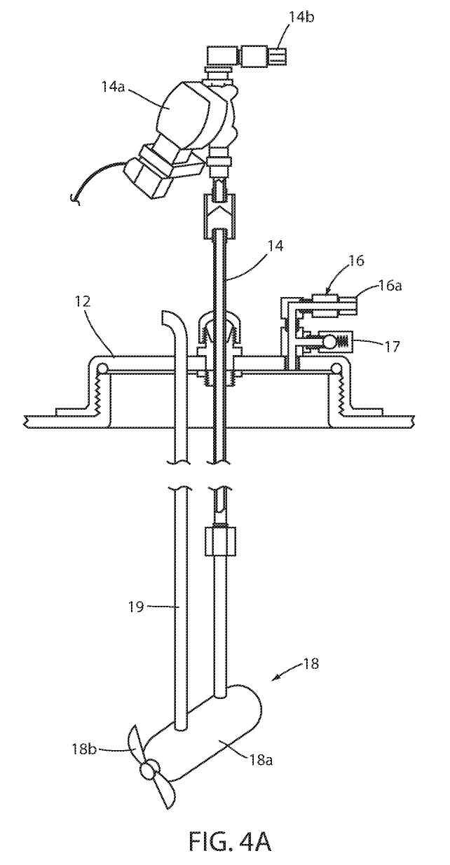

Cap 12 is fitted with two connections to air compressor system 20 (FIGS. 3 and 4). Bubbler air delivery tube 14 projects through cap 12 and is joined at its bottom end to bubbler 13. Bubbler air delivery line 24 is connected to bubbler delivery tube 14 via quick disconnect connector 14b on the top end of tube 14. A computer controlled or timer valve 14a at the top of bubbler delivery tube 14 intermittently opens for brief times to allow air to flow through tube 14 and through bubbler 13, thereby gently stirring the liquid asphalt suspension for a time and at intervals appropriate to keep solids from settling.

In the alternative embodiment shown in FIG. 4A, bubbler 13 is replaces with an motor driven stirrer 18, comprised of a motor 18a which rotates a stirring propeller or paddle 18b. Compressed air is fed into air driven motor 18a and exits through exhaust pipe 19. Exhaust pipe 19 extends all the way up from motor 18a, and out through an opening in cover 12. In this way, compressed air does not build up inside tank 11 as a result of the periodic stirring of the liquid asphalt composition. Foaming of the liquid asphalt is also minimized; making it less likely that pressure relief valve 17 will become plugged.

A pressurizing fitting 16 is connected to pressurizing air line 25 via a quick disconnect connector 16a. Compressed air delivered via line 25 places container 11 under a pressure of about 4-6 psi, which forces liquid asphalt through delivery line 15b to mixer/delivery unit 70. Fitting 16 includes a pressure relief valve 17, which keeps container 11 from being over pressurized.

Compressed air system 20 comprises a compressor tank 21 and regulator 21b, pressurized by a compressor pump 21a to a regulated delivery pressure of about 120 psi (FIG. 3), established by pressure regulator 21b. A computer and/or manual shut off valve 21c shuts off the flow of compressed air through line 22, when the apparatus is shut down. Compressed air line 22 flows from tank 21 to a manifold 22a. Manifold 22a includes multiple quick disconnect ports having shut off valves 22b, which can be manual and/or computer operated. Air line 24 is connected to one of the manifold ports, and air line 25 to another. Air line 24 delivers air under pressure to bubbler 13 (FIG. 4) or air driven stirrer 18 (FIG. 4A) via its connection to delivery pipe 14. The compressed air can be delivered at about 120 psi, since it is vented either by pressure relief valve 17, or by air motor exhaust line 19. Computerized valve 14a intermittently opens to allow air to pass into delivery tube 14 and through bubbler 13 or through air driven motor 18.

Air line 25 delivers compressed air to a step down pressure regulator assembly 23, and from there to connector fitting 16 for pressurizing tank 11. The first regulator 23a in the line of flow of regulator assembly 23 steps the pressure down from about 120 psi to about 30 psi. The second regulator 23b steps the pressure down from about 30 psi to about 4-6 psi. This results in a far more consistent level of air pressure delivered to tank 11 than can be achieved using a single 4-6 psi regulator.

When the pothole filling apparatus 1 is being used to fill a pothole, valve 22b on delivery line 25 is opened. Compressed air flows through line 25 and step down regulator 23 to pressure fitting 16 and into container 11. This facilitates liquid asphalt delivery under pressure to mixer/delivery unit 70. When the apparatus is not being used to fill, the valve 22b on line 25 is closed. The valve 22b on air delivery line 24 can always be open when the apparatus is in use. When bubbler 13 is used, valve 14a is held closed, so as to avoid varying the air pressure within tank 11 during the filling operation. When air driven stirrer 18 is used, valve 14a can continue to operate intermittently during the filling operation, as the air delivered to air motor 18a is exhausted to the atmosphere through exhaust pipe 19.

Aggregate delivery system 30 comprises an aggregate hopper 31, having lower sides 31a which slope inwardly and downwardly towards one another (FIGS. 2 and 5). The parallel end walls 31b are vertical such that an elongated trough is created at the bottom of hopper 31. An aggregate delivery auger 32 is located at the base of the trough, and extends outwardly from hopper 31 through auger conduit 33. Delivery auger 32 is connected to and driven by hydraulic motor 34 at one end, and is mounted in a bearing 32a at the end of auger conduit 33. Auger conduit 33 includes a top inlet 33a at the downstream end of conduit 33, to which the outlet of activator delivery unit 40 is attached. A connector ring 35 located at top inlet 33a facilitates connecting activator delivery unit 40 to top inlet 33a. A bottom outlet 33b opposite top outlet 33a empties aggregate and activator into the delivery extender system 50.

Activator delivery system 40 comprises an activator container 41 with a funnel shaped bottom portion 41a (FIG. 5). Connector ring 44 is secured to the bottom portion 41a of container 41, and is connected to connector ring 35 of conduit 33 to mount activator delivery system to conduit 33. A delivery auger 42 extends generally from the top of container 41 to its bottom, and partially into the passage way through connector ring 44. Augur 42 includes paddles extending from the auger shaft between flutes of the auger. Auger 41 is rotated by a hydraulic auger motor 43 positioned on top of container 41. Motor 43 is computer controlled to meter the rate at which activator is fed into aggregate passing through conduit 33 below. This sets the desired the flow rate so as to achieve the desired activator to aggregate ratio delivered to mixer/delivery unit 70.

Delivery extender system 50 comprises first and second augers 51 and 54 and their associated conduits 52 and 55, which combine to mix and deliver aggregate and activator to the mixer/delivery unit 70 (FIGS. 2, 5 and 6). The inlet 52a in the top of the upstream end of auger conduit 52 is connected by swivel joint 60 to the outlet 33b of aggregate auger conduit 33 (FIG. 5). At its opposite end, the outlet 52b of auger conduit 52 is connected by swivel joint 60 to the inlet end 55a of auger conduit 55 (FIG. 6). The outlet opening 55b at the opposite end of conduit 55 is connected to mixer/delivery unit 70. Swivel joints 60 permit a user to “unfold” delivery extender system 50 from its stored position as shown in FIG. 1, to its extended position shown in FIG. 2. It permits mixer/delivery head 70 to be positioned over potholes at various locations within the range of motion of delivery system 50, without having to move the pot-hole filling apparatus 1.

The inlets 52a and 55a of each auger conduit 52 and 55 are located on the top of the auger conduit at its upstream end, and the outlets are located on the bottom of the auger conduits, at the downstream end of each conduit. Each auger 51 and 54 is mounted in a bearing 51a and 54a, respectively, at each end of their respective conduits. Each auger is connected to and driven by a hydraulic motor, 53 or 56, respectively, at the other end of its conduit.

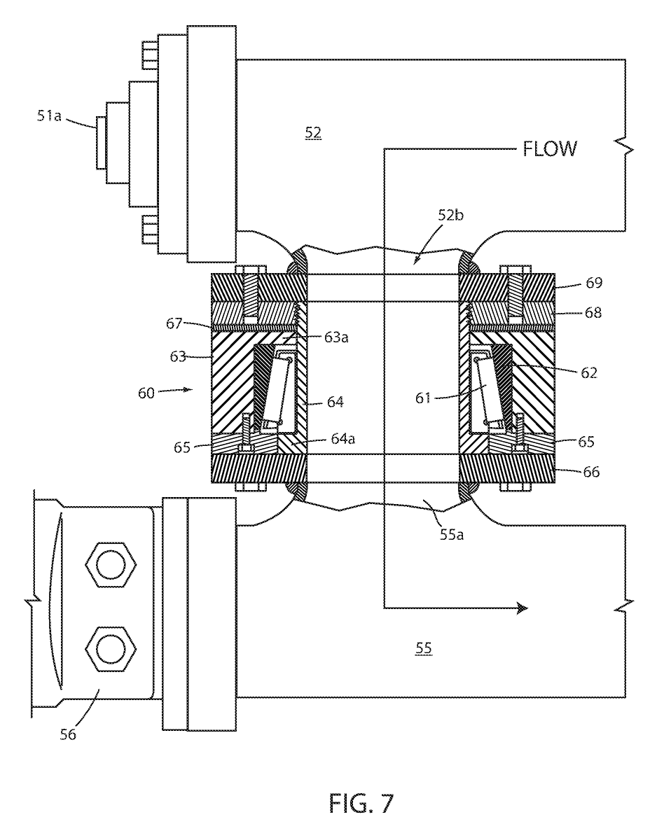

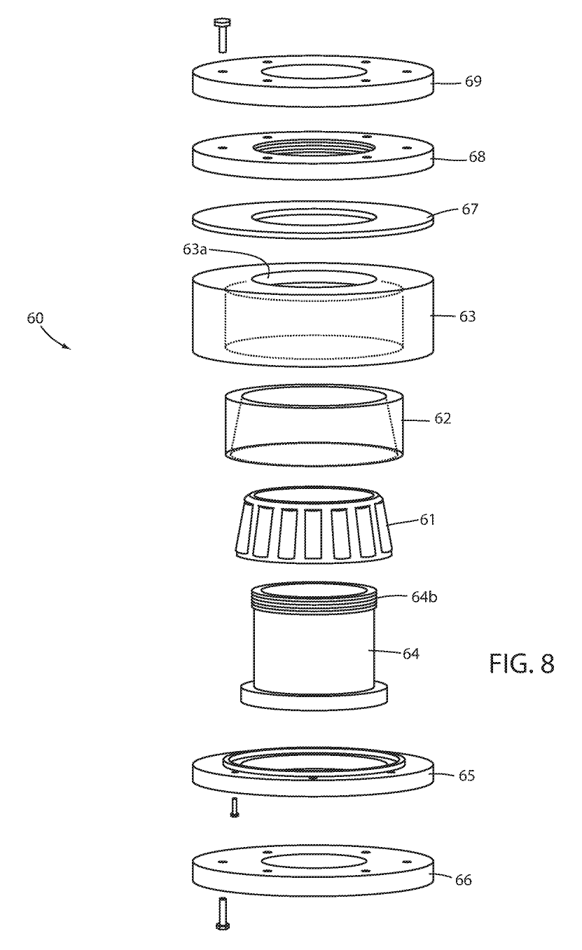

Each swivel joint 60 comprises a bearing assembly consisting of an inner race and plural bearing assembly 61, and a bearing outer race 62 (FIGS. 7 and 8), which facilitate rotation of swivel joint 60. A sleeve like bearing housing 63 comprises an outer perimeter wall having a top and a bottom, and a top lip 63a extending inwardly from said perimeter wall at said top thereof. A bottom retainer ring 65 is secured to the bottom of said perimeter wall of said bearing housing 63, and extending inwardly beyond the interior of perimeter wall. Bottom retainer ring 65 includes an annular bead 65a on its upper surface, which is positioned to locate bearing housing 63 on bottom retainer ring, with bead 65a being positioned just inside the bottom of bearing housing annular side wall. An upper securement ring 68 is positioned on top of said bearing housing 63, with a spacer slip washer 67 positioned there between, such that upper securement ring 68 is rotatable relative to said bearing housing 63. Said upper securement ring and said spacer slip washer extend inwardly to the extent of the top lip 63a on said bearing housing. The bearing assembly of inner race, plural bearings and outer race are sandwiched between the upper lip 63a of housing 63 and the bottom retainer ring 65.

An inner sleeve 64 is secured to upper securement ring 68 by mating threads on the inner edge of securement ring 68 and on the outer surface of the top of the inner sleeve 64. A set screw locks the securement ring 68 and inner sleeve 64 together such that they rotate together. Inner sleeve 64 extends entirely down the length of the bearing assembly and includes an outwardly extending bottom lip 64a which abuts but is rotatable with respect to the interior surface of bottom retainer ring 65.

A top connector ring 69 is bolted to securement ring 68. A bottom connector ring 66 is bolted to bottom retainer ring 65. Connector rings 69 and 66 facilitate connection of the swivel joint 60 to the various outlets and inlets which must rotate relative to each other, e.g. outlet 52b of housing 52 and inlet 55a of housing 55 (FIG. 7). Anything connected to upper connector ring 69 rotates as a unit with upper securement ring 68 and inner sleeve 64. Anything connected to bottom connector ring 66 rotates as a unit with bottom retainer ring 65 and bearing housing 63. Yet inner sleeve 64 protects the bearing assembly from, and minimizes contamination by, material passing through inner sleeve 64. The bearing and race assembly 61 and the outer race 62 are totally sealed from aggregate and activator material passing through each joint 60. Inner sleeve 64 serves as a passageway for aggregate and activator going through joint 60, and also protects the bearing assembly from the aggregate and actuator.

Mixing and delivery unit 70 comprises a mixing and delivery auger 71, housed within conduit 72 (FIG. 6). Conduit 72 includes an inlet 72a at its upstream end, and an outlet spout 72b at its downstream end. Auger 71 is mounted in a bearing to hydraulic motor 73, but is free floating at its downstream outlet end. A liquid asphalt delivery pipe 74 is secured to conduit 72 at a distance sufficiently far from the downstream end of auger 71 that the liquid asphalt gets well mixed with aggregate and activator before the mixture exits outlet spout 72b, and sufficiently far from the upstream inlet end of conduit 72 that the mixture of liquid asphalt, aggregate and activator does not begin to become prematurely hardened or stiffened within conduit 72, before it is delivered to the pot hole at outlet 72b. A flow meter 75, preferably computer controlled, is located at the upper end of delivery pipe 74, to meter the rate of flow of liquid asphalt into mixer/delivery unit 70 at the proper rate, to achieve the desired hardening rate and formulary constitution of the asphalt, aggregate and activator mixture being applied to the pothole. A quick disconnect connector 74a is positioned at the top of delivery pipe 74 to facilitate connection to liquid asphalt deliver line 15b. A manual ball valve 76 is provided on delivery pipe 74, which the operator can turn on or off, or to intermediate positions, to control the flow of the asphalt, aggregate, and activator mixture into the pot hole.

The flite pitch of the auger 71 is from about 2.7-2.8 inches, preferably about 2.75 inches. In addition, mixing tines 71a are located on the auger shaft between the flites to about ½ the height of the flite. Mixing auger 71 is preferably about 18 inches in length.

The water clean out system 80 comprises a water tank 81 from which water is pumped through water delivery line 82 by water pump 83 (FIG. 9). Water delivery line 82a connects to a computer controlled diverter valve 84, which diverts the flow of water either through water delivery line 82a or line 82b. Line 82a is connected to liquid asphalt delivery pipe 74, just above conduit 72 of mixer/delivery unit 70. Water delivery line 82 b is connected to an inlet at liquid asphalt delivery spigot 15, so as to direct water through liquid asphalt delivery line 15b.

If use of the apparatus is discontinued between jobs for a short period of time, water delivery line 82 is opened by diverter valve 84 to delivery line 82a, causing clean out of mixer/delivery unit 70. When use of apparatus 1 is discontinued for the day, the operator can signal diverter valve 84 to divert the flow of water to line 82b, and thus flush out the entire liquid asphalt delivery line 15b and the entire liquid asphalt delivery pipe 74, as well as auger conduit 72.

A mixer/delivery unit clean out is provided, wherein the unit is operated at increased speed a short time after the unit stops operating. If the mixer/delivery auger 71 stops turning for a period of time when the pot hole filler apparatus 1 in use, the cleanout system automatically increases the rate at which auger 71 is operated for 45-60 seconds. This clears any mixture of aggregate, asphalt and activator out of mixing/delivery unit 70, and prevents it from hardening and preventing further operation of unit 70. Auger 71 normally operates at about 200 to 240 rpm. If the auger stops turning for a period of time, e.g. 100-200 seconds, the computer causes the auger to turn at about 1,000 rpm for 45-60 seconds.

In use, pot hole filler apparatus is prepared by loading aggregate into hopper 31, loading activator into container 41, and loading a tote of liquid asphalt 11 into frame 11a (or otherwise filling liquid asphalt container 11). Liquid asphalt line 15b, compressed air lines 24 and 25, and water delivery line 82b are connected via their quick disconnect connectors to their corresponding connections in the liquid asphalt delivery system 10. The system is activated such that compressed air is periodically delivered through bubbler line 24, bubbler delivery tube 14 and bubbler 13, under control of computer operated air valve 14a, thus keeping asphalt solids in suspension.

The unit 1 can be self-propelled, or can be hitched to and conveyed by a truck to an area where potholes are to be filled. En route, one may turn the unit on and open valve 226 on air line 24, to allow the bubbler 13 or air driven stirrer 18 to intermittently stir the liquid asphalt component. When one reaches the area requiring repair, one positions unit 1 near the potholes to be filled, and unfolds extender auger system 50 in such a way as to position mixer/delivery unit 70 over any nearby pothole or potholes. The operator then opens valve 22a on air delivery line 25, to place tank 11 under 4-6 psi pressure. The operator positions mixer/delivery unit 70 over the pothole, opens valve 76, and allows the asphalt, aggregate and activator mixture to flow into the pot hole, until the hole is filled to its top. Valve 76 is then closed, and mixer/delivery unit 70 located over the next pot hole.

When the filling operation is temporarily stopped for a user programmed amount of time, e.g. 100-200 seconds, computer 4 activates the motor of auger 71 to rotate at about 1,000 rpm for 45-60 seconds. The system can thus be prevented from freezing up during an idle period, or when the apparatus is shut down for the day.

In addition, when the system is shut down between jobs, water delivery line 82 is opened by diverter valve 84 to delivery line 82a, causing clean out of mixer/delivery unit 70. When use of apparatus 1 is discontinued for the day, the operator can signal diverter valve 84 to divert the flow of water to line 82b, and thus flush out the entire liquid asphalt delivery line 15b and the entire liquid asphalt delivery pipe 74, as well as auger conduit 72.

Of course, it is understood that the foregoing is a description of the preferred embodiments of the invention, and that various changes and alterations can be made without departing from the spirit and scope of the invention, as set forth in the appended claims.

1. An apparatus for filling potholes with a liquid pot-hole filler comprising:
a liquid asphalt delivery system; a compressed air system; an aggregate delivery system; an activator delivery system; a mixing unit; said liquid asphalt delivery system including a liquid asphalt tank and conduit for delivering liquid asphalt to said mixing unit; said aggregate delivery system including an aggregate hopper and conduit for delivering aggregate to said mixing unit; said activator delivery system including an activator container and conduit for delivering activator to said mixing unit; said compressed air system being operable to supply compressed air to said liquid asphalt tank, thereby forcing liquid asphalt through said liquid asphalt conduit to said mixing unit, whereby liquid asphalt is mixed with aggregate and activator in said mixing unit; said mixing unit being connected to a delivery opening through which the mixture of liquid asphalt, aggregate and activator are delivered into a pot-hole to be filled.

2. The apparatus of claim 1 in which said liquid asphalt container comprises a tote in which said liquid asphalt can be separately stored and delivered; said apparatus including a holding frame for said tote; said tote being readily connectable and dis-connectable to said liquid asphalt delivery conduit.

3. The apparatus of claim 1 in which said aggregate delivery system conduit includes a first conduit extender unit which is connected to a second conduit extender unit by a first swivel unit, said first swivel joint including a top portion with a top opening and a bottom portion with a bottom opening, said top and bottom portions including a swivel bearing there between whereby they can be readily rotated relative to one another; said first swivel joint including an internal sleeve connected to one of said top and bottom swivel portions and extending from said top opening to said bottom opening to the inside of said swivel bearing, for guiding aggregate through said swivel joint and protecting said swivel bearing.

4. The apparatus of claim 3 in which said aggregate hopper includes an auger at the bottom of said hopper which conveys aggregate into an outlet conduit extending from said hopper; said first extender unit being connected at one end to said aggregate hopper outlet conduit by a second swivel joint, having a construction like that of said first swivel joint, whereby said first conduit extender can be swiveled relative to said aggregate outlet conduit.

5. The apparatus of claim 4 in which said conduit extender units comprise conduits which house augers, each said auger including a motor for driving said auger located outside of and at one end of said conduit, and a bearing in which said auger is mounted located at the other end of said conduit.

6. The apparatus of claim 4 in which each of said swivel joints comprises: said swivel bearing comprising a bearing assembly comprising a plurality of bearings positioned between an inner race and an outer race; a sleeve like bearing housing comprising an outer perimeter wall having a top and a bottom, and a top lip extending inwardly from said perimeter wall at said top thereof; a bottom retainer ring secured to said bottom of said perimeter wall of said bearing housing, and extending inwardly beyond the interior of perimeter wall; an upper securement ring is positioned on top of said bearing housing and is rotatable relative thereto; an inner sleeve is secured to said securement ring and rotates there with, said inner sleeve extending entirely down the length of said bearing assembly and includes an outwardly extending bottom lip which abuts but is rotatable with respect to the interior surface of said bottom retainer ring; whereby a first member secured to said upper securement ring and a second member secured to said bottom retainer ring can be rotated relative to one another, and such that contamination of said bearing assembly by material passing through said inner sleeve is minimized.

7. The apparatus of claim 6 in which said upper securement ring is positioned on said bearing housing by being seated on a slip washer, which in turn is seated on said bearing housing.

8. The apparatus of claim 1 which also comprises: a water clean out system which includes a water tank, a pump and a first conduit from said pump to said mixing unit whereby said mixing unit can be cleaned out when not in use mixing and delivering said mixture to a pot-hole to be filled.

9. The apparatus of claim 8 in which said water clean out system also includes: a valve operably associated with said pump and said first conduit; and a second conduit extending from said valve to said liquid asphalt delivery conduit; said valve being switchable to alternatively open flow through said first conduit and close it to said second conduit, or vice versa, whereby the flow of water from said pump can be directed directly to said mixing unit through said first conduit, or can be directed through both said liquid asphalt delivery conduit and said mixing unit via opening flow to said second conduit.

10. The apparatus of claim 1 comprising said mixing unit including a rate adjustable auger which mixes and delivers a mixture of liquid asphalt, aggregate and activator; a computer programmed to automatically turn on said auger after it has been shut off for a short time, and to operate said auger at a substantially increased rate of operation relative to rates normally used to mix and deliver said aggregate, whereby said mixing unit is substantially cleaned of said mixture.

11. The apparatus of claim 10 wherein said auger normally operates at about 200 to 240 rpm, and if said auger stops turning for from about 100 to about 200 seconds, said computer causes said auger to turn at about 1,000 rpm for about 45 to about 60 seconds.

12. The apparatus of claim 1 comprising: said compressed air system including a compressor, a compressed air tank, and first and second separate conduits operably connected to said compressed air tank and to said liquid asphalt tank, said first conduit delivering said air under pressure to effect delivery of said liquid asphalt to said mixing unit, and said second conduit delivering air under pressure into said tank for intermittently stirring a liquid asphalt composition contained in said tank.

13. The apparatus of claim 12 in which said liquid asphalt tank includes a bubbler connected to said second conduit of said compressed air system, whereby liquid asphalt contained in said tank is stirred by air bubbling through said bubbler.

14. The apparatus of claim 12 in which said liquid asphalt tank includes an air powered stirrer connected to said second conduit of said compressed air system, whereby liquid asphalt contained in said tank is stirred by air passing through and powering said stirrer; said stirrer including an air exhaust conduit open to the atmosphere outside of said tank, whereby air passing through said stirrer is exhausted to atmosphere rather than to the interior of said tank.

15. The apparatus of claim 12 in which said second conduit includes a computer controlled or timer controlled valve on said second compressed air conduit which intermittently opens said valve for brief times to allow air to flow through said second conduit to effect said intermittent stirring of said liquid asphalt.

16. The apparatus of claim 12 which includes a fitting operably connected to said liquid asphalt tank, to which said first conduit can be connected; said fitting including a pressure relief valve to prevent said tank from becoming over pressurized.

17. The apparatus of claim 12 in which said compressed air delivery system includes a manifold having an inlet port and at least two valve controlled outlet ports; a compressed air delivery conduit connecting said compressed air tank to said manifold: each said first and second conduits being connected to a separate one of said valve operated manifold ports.

18. The apparatus of claim 12 in which said first conduit includes a step down regulator including a first regulator for reducing the pressure of air being delivered from said compressed air tank from about 120 psi to about 30 psi, and a second regulator downstream thereof for reducing the pressure being delivered through said first conduit from about 30 psi to about 4-6 psi.

19. The apparatus of claim 1 in which said activator delivery system includes an activator holder container having a funnel shaped bottom portion and a bottom opening; a motor driven activator delivery auger located within said activator container and extending to said bottom opening; said auger including stirring paddles located between the flites of said auger.

20. The apparatus of claim 19 in which said bottom opening is connected to said aggregate delivery conduit, whereby said aggregate delivery conduit also serves as said activator delivery conduit, and whereby activator and aggregate are mixed as they are delivered through said aggregate delivery conduit to said mixing unit.

21. The apparatus of claim 20 in which said activator delivery auger includes a variable speed control to facilitate metering the rate at which activator is fed from said bottom opening of said activator container.

22. An apparatus for filling potholes with a liquid pot-hole filler comprising:
a liquid asphalt delivery system; a compressed air system; an aggregate delivery system; an activator delivery system; a mixing unit; said liquid asphalt delivery system including a liquid asphalt tank and conduit for delivering liquid asphalt to said mixing unit; said aggregate delivery system including an aggregate hopper and conduit for delivering aggregate to said mixing unit; said activator delivery system including an activator container and conduit for delivering activator to said mixing unit; said compressed air system being operable to supply compressed air to said liquid asphalt tank, thereby forcing liquid asphalt through said liquid asphalt conduit to said mixing unit, whereby liquid asphalt is mixed with aggregate and activator in said mixing unit; said mixing unit being connected to a delivery opening through which the mixture of liquid asphalt, aggregate and activator are delivered into a pot-hole to be filled; said aggregate delivery system conduit including a first conduit extender unit which is connected to a second conduit extender unit by a first swivel unit, said first swivel joint including a top portion with a top opening and a bottom portion with a bottom opening, said top and bottom portions including a swivel bearing there between whereby they can be readily rotated relative to one another; said first swivel joint including an internal sleeve connected to one of said top and bottom swivel portions and extending from said top opening to said bottom opening to the inside of said swivel bearing, for guiding aggregate through said swivel joint and protecting said swivel bearing; a water clean out system which includes a water tank, a pump and a first conduit from said pump to said mixing unit whereby said mixing unit can be cleaned out when not in use mixing and delivering said mixture to a pot-hole to be filled; a valve operably associated with said pump and said first conduit; and a second conduit extending from said valve to said liquid asphalt delivery conduit; said valve being switchable to alternatively open flow through said first conduit and close it to said second conduit, or vice versa, whereby the flow of water from said pump can be directed directly to said mixing unit through said first conduit, or can be directed through both said liquid asphalt delivery conduit and said mixing unit via opening flow to said second conduit. said mixing unit including a rate adjustable auger which mixes and delivers a mixture of liquid asphalt, aggregate and activator; a computer programmed to automatically turn on said auger after it has been shut off for a short time, and to operate said auger at a substantially increased rate of operation relative to rates normally used to mix and deliver said aggregate, whereby said mixing unit is substantially cleaned of said mixture.

23. The apparatus of claim 22 comprising: said compressed air system including a compressor, a compressed air tank, and first and second separate conduits operably connected to said compressed air tank and to said liquid asphalt tank, said first conduit delivering said air under pressure to effect delivery of said liquid asphalt to said mixing unit, and said second conduit delivering air under pressure into said tank for intermittently stirring a liquid asphalt composition contained in said tank.

24. The apparatus of claim 23 in which said activator delivery system includes an activator holder container having a funnel shaped bottom portion and a bottom opening; a motor driven activator delivery auger located within said activator container and extending to said bottom opening; said auger including stirring paddles located between the flutes of said auger.

25. An apparatus for filling potholes with a liquid pot-hole filler comprising:
a liquid asphalt delivery system; a mixing unit; said liquid asphalt delivery system including a liquid asphalt tank and conduit for delivering liquid asphalt to said mixing unit; said aggregate delivery system including an aggregate hopper and conduit for delivering aggregate to said mixing unit; said activator delivery system including an activator container and conduit for delivering activator to said mixing unit; said liquid asphalt delivery system being operable to supply liquid asphalt through said liquid asphalt conduit to said mixing unit, whereby liquid asphalt is mixed with aggregate and activator in said mixing unit; said mixing unit being connected to a delivery opening through which the mixture of liquid asphalt, aggregate and activator are delivered into a pot-hole to be filled; said aggregate delivery system conduit includes a first conduit extender unit which is connected to a second conduit extender unit by a first swivel unit, said first swivel joint including a top portion with a top opening and a bottom portion with a bottom opening, said top and bottom portions including a swivel bearing there between whereby they can be readily rotated relative to one another; said first swivel joint including an internal sleeve connected to one of said top and bottom swivel portions and extending from said top opening to said bottom opening to the inside of said swivel bearing, for guiding aggregate through said swivel joint and protecting said swivel bearing.

26. An apparatus for filling potholes with a liquid pot-hole filler comprising:
a liquid asphalt delivery system; a mixing unit; said liquid asphalt delivery system including a liquid asphalt tank and conduit for delivering liquid asphalt to said mixing unit; said aggregate delivery system including an aggregate hopper and conduit for delivering aggregate to said mixing unit; said activator delivery system including an activator container and conduit for delivering activator to said mixing unit; said liquid asphalt delivery system being operable to supply liquid asphalt through said liquid asphalt conduit to said mixing unit, whereby liquid asphalt is mixed with aggregate and activator in said mixing unit; said mixing unit being connected to a delivery opening through which the mixture of liquid asphalt, aggregate and activator are delivered into a pot-hole to be filled; a water clean out system which includes a water tank, a pump and a first conduit from said pump to said mixing unit whereby said mixing unit can be cleaned out when not in use mixing and delivering said mixture to a pot-hole to be filled; a valve operably associated with said pump and said first conduit; and a second conduit extending from said valve to said liquid asphalt delivery conduit; said valve being switchable to alternatively open flow through said first conduit and close it to said second conduit, or vice versa, whereby the flow of water from said pump can be directed directly to said mixing unit through said first conduit, or can be directed through both said liquid asphalt delivery conduit and said mixing unit via opening flow to said second conduit.

27. An apparatus for filling potholes with a liquid pot-hole filler comprising:
a liquid asphalt delivery system; a mixing unit; said liquid asphalt delivery system including a liquid asphalt tank and conduit for delivering liquid asphalt to said mixing unit; said aggregate delivery system including an aggregate hopper and conduit for delivering aggregate to said mixing unit; said activator delivery system including an activator container and conduit for delivering activator to said mixing unit; said liquid asphalt delivery system being operable to supply liquid asphalt through said liquid asphalt conduit to said mixing unit, whereby liquid asphalt is mixed with aggregate and activator in said mixing unit; said mixing unit being connected to a delivery opening through which the mixture of liquid asphalt, aggregate and activator are delivered into a pot-hole to be filled; said mixing unit including a rate adjustable auger which mixes and delivers a mixture of liquid asphalt, aggregate and activator; a computer programmed to automatically turn on said auger after it has been shut off for a short time, and to operate said auger at a substantially increased rate of operation relative to rates normally used to mix and deliver said aggregate, whereby said mixing unit is substantially cleaned of said mixture.

28. A swivel joint for joining first and second members in a swiveling relationship, said swivel joint including a top portion with a top opening and a bottom portion with a bottom opening, said top and bottom portions including a swivel bearing there between whereby they can be readily rotated relative to one another; said swivel joint including an internal sleeve connected to one of said top and bottom swivel portions and extending from said top opening to said bottom opening to the inside of said swivel bearing, for guiding material through said swivel joint and protecting said swivel bearing.

29. The swivel joint of claim 28 which comprises: said swivel bearing comprising a bearing assembly comprising a plurality of bearings positioned between an inner race and an outer race; a sleeve like bearing housing comprising an outer perimeter wall having a top and a bottom, and a top lip extending inwardly from said perimeter wall at said top thereof; a bottom retainer ring secured to said bottom of said perimeter wall of said bearing housing, and extending inwardly beyond the interior of perimeter wall; an upper securement ring is positioned on top of said bearing housing and is rotatable relative thereto; an inner sleeve is secured to said securement ring and rotates there with, said inner sleeve extending entirely down the length of said bearing assembly and includes an outwardly extending bottom lip which abuts but is rotatable with respect to the interior surface of said bottom retainer ring; whereby a first member secured to said upper securement ring and a second member secured to said bottom retainer ring can be rotated relative to one another, and such that contamination of said bearing assembly by material passing through said inner sleeve is minimized.

30. The swivel joint of claim 29 in which said upper securement ring is positioned on said bearing housing by being seated on a slip washer, which in turn is seated on said bearing housing.

31. A method for filling potholes with a liquid pot-hole filler comprising:
providing a liquid asphalt delivery system; a compressed air system; an aggregate delivery system; an activator delivery system; a mixing unit; said liquid asphalt delivery system including a liquid asphalt tank and conduit for delivering liquid asphalt to said mixing unit; said aggregate delivery system including an aggregate hopper and conduit for delivering aggregate to said mixing unit; said activator delivery system including an activator container and conduit for delivering activator to said mixing unit; said compressed air system being operable to supply compressed air to said liquid asphalt tank;
operating said aggregate delivery system to deliver aggregate to said mixing unit;
operating said activator delivery system to deliver activator to said mixing unit;
operating said compressed air system to force liquid asphalt through said liquid asphalt conduit to said mixing unit, whereby liquid asphalt is mixed with aggregate and activator in said mixing unit; said mixing unit being connected to a delivery opening through which the mixture of liquid asphalt, aggregate and activator are delivered into a pot-hole to be filled.
